(19) United States
(12) Patent Application Publication
(10) Pub. No.: US 2010/0020551 A1
(43) Pub. Date: Jan. 28, 2010

(54) Recessed lighting fixture

(75) Inventors: Gregory L. Kay, Chicago, IL (US); Aaron O'Brien, Munster, IN (US)

Correspondence Address: WOOD, PHILLIPS, KATZ, CLARK & MORTIMER, 500 W. MADISON STREET, SUITE 3800, CHICAGO, IL, 60661, US

(73) Assignee: Lightology, Inc.

(21) Appl. No.: 12/220,297

(22) Filed: Jul. 23, 2008

(51) Int. Cl. F21V 15/00

(52) U.S. Cl. 362/365

(57) ABSTRACT

A recessed lighting fixture comprises a base plate mountable in an opening in a room ceiling or wall, the base plate defining spaced apart front and back surfaces wherein the front surface is substantially flat and aligned with the surface of the ceiling or wall when mounted thereon, capable of being plastered and painted to match the ceiling or wall into which it is installed, the plate having an opening to allow light to pass through. A two-part, expandable housing substantially surrounds the base plate, the housing consisting of an upper and lower assembly, with the base plate secured to the lower portion and the lower portion adjustably mounted to the upper portion of the housing. A curved dome is adjustably mounted adjacent the back surface of the base plate, contained within the housing and centered on the light opening.

### CROSS-REFERENCE TO RELATED APPLICATIONS

Not applicable.

### FIELD OF THE INVENTION

The present invention relates to lighting fixtures, and more particularly, to recessed lighting fixtures.

### BACKGROUND OF THE INVENTION

Recessed lighting systems are well known. Such systems provide a light source from behind the surface or a wall or ceiling, and therefore do not protrude into the room to any great degree but instead locate the light components in space behind the wall or ceiling.

Such systems are desirable for a variety of reasons, one significant one being that they do not visually intrude significantly into the appearance of the room and therefore may readily blend with almost any decor. Notwithstanding this, many recessed lights are far from being hidden from notice.

For example, many recessed lighting fixtures include a frame, a reflector, a junction box and structure for attaching the frame to the ceiling. The junction box is typically required by code, and is an enclosure mounted on the frame that functions as a receptacle for joining the wires from an electrical power source and a lamp socket in the reflector. The frame is suitably mounted to the ceiling (e.g., by a barbed insert that can be nailed into a wooden beam in the ceiling) and includes an opening through which the reflector is inserted to direct light to an area below the lighting fixture (e.g., down at an angle away from the lighting fixture or down from the lighting fixture). Different mechanisms have been used to retain the reflector in the frame. For example, the reflector may have an opening with a circumference that is larger than the opening in the frame. In such a configuration, the reflector sits on the top surface of the frame and surrounds the opening with a trim ring that is readily visible to anyone in the room. Further, the reflector visible through the wall or ceiling opening will often be silver or some other color which may functionally reflect light but will also provide an obvious visible contrast with the wall or ceiling around it.

A recessed lighting fixture of the above general type is shown, for example, in U.S. Pat. No. 6,431,723

Another reason that recessed lighting systems are desirable is that they may provide more indirect lighting, thereby reducing the glare from the light source (e.g., an incandescent lamp). However, in many such systems, the lights are often still readily visible from many different positions in the room and, particularly given the brightness of spotlights often used in such systems, can cause a person who happens to look into the fixture discomfort and some disorientation due to closing of their irises and therefore insufficient dilation of their irises when they look away from the light.

In short, while recessed lighting systems provide many different types of advantages, those long desired advantages still have not been fully provided.

Pending application Ser. No. 11/440,961, owned by the assignee of the present application, describes an improved recessed lighting fixture and particularly the mechanical construction of the fixture. The use of RGB LED's and an arcuate positioning rack are particularly described.

Additional areas for improvements include how to make the fixture flush after power was brought to the light fixture, in ceilings greater than ½″ thick. For those locations which required a trim, there was no option or construction which would accept it. Known fixtures do not improve upon the industry standard junction box, requiring more labor to install. The known fixtures use traditional style bar hangers to mount the fixture, resulting in more labor to install the fixture. Although the known fixtures offer an acceptable shielding angle, no information is provided regarding the proper lamp position when creating a flush mounted design. The LED's used in the known fixtures require power to run as well as signal power to communicate the desired intensity. This power is typically limited to one signal protocol at the factory, forcing the customer to buy compatible accessories for only that signal type, with no chance to change their mind after the installation is complete, sometimes, locking a customer into a choice which is more expensive than their needs. The life of the typical MR16 lamp used within the known fixtures can be shortened when the lamp is pushed to run at temperatures beyond its limits. This will make for frequent lamp changes which are costly and may require more fixture maintenance if the inside becomes dirty during the service. Plastering in the known fixtures is difficult due to lack of a clean break line between the plaster flange frame and the ceiling plane. This increases the time needed to install the fixture.

The present invention is directed toward further improvements in recessed lighting fixtures, particularly relating to easing installation and alternate options which include trims.

### SUMMARY OF THE INVENTION

In accordance with the invention, a recessed lighting fixture comprises a base plate mountable in an opening in a room ceiling or wall, the base plate defining spaced apart front and back surfaces wherein the front surface is substantially flat and aligned with the surface of the ceiling or wall when mounted thereon, capable of being plastered and painted to match the ceiling or wall into which it is installed, said plate having an opening to allow light to pass through. A two-part, expandable housing substantially surrounds the base plate, the housing consisting of an upper and lower assembly, with the base plate secured to the lower portion and the lower portion adjustably mounted to the upper portion of the housing. A curved dome is adjustably mounted adjacent the back surface of the base plate, contained within the housing and centered on said light opening.

Further features and advantages of the invention will be apparent form the specification and the drawings.

### BRIEF DESCRIPTION OF THE DRAWINGS

FIG. 1 is a perspective view of a recessed lighting fixture in accordance with the invention;

FIG. 2 is a perspective view, similar to FIG. 1, with a plaster plate assembly removed and the fixture ready for installation between joists;

FIG. 3 is a partial perspective view illustrating opening of a junction box about a first axis;

FIG. 4 is a view, similar to FIG. 3, illustrating opening of the junction box about a second axis;

FIG. 5 is a perspective view, similar to FIG. 2, illustrating a two part adjustable housing;

FIG. 6 is a perspective view illustrating drywall installation;

FIG. 7 is a perspective view illustrating vertical adjusting of the two part housing flush with the drywall;

FIG. 8 is a sectional view illustrating the vertical adjustment of FIG. 7;

FIGS. 9 and 10 are perspective views illustrating installation of the plaster plate assembly;

FIG. 11 is a perspective view illustrating plastering of the recessed lighting fixture;

FIG. 12 is a perspective view illustrating sanding of the recessed lighting fixture;

FIG. 13 is a perspective view illustrating painting of the ceiling with the recessed lighting fixture;

FIG. 14 is a perspective view illustrating removal of a paint shield;

FIGS. 15 and 16 are side, partial sectional views, illustrating adjustable positioning of a lamp in the recessed light fixture;

FIGS. 17 and 18 are schematic drawings illustrating electrical installation options of the recessed lighting fixture in accordance with the invention;

FIG. 19 is a perspective view of a pan tilt mechanism of the plaster plate assembly; and

FIG. 20 is an exploded view of the lamp assembly.

### DETAILED DESCRIPTION OF THE INVENTION

The present invention resolves the issues noted above and improves the performance of recessed lighting fixtures, as is described below.

A recessed lighting fixture in accordance with the invention has a two piece housing which consists of a box style enclosure and a plaster flange frame. The box style enclosure is supported by mounting bars and the plaster flange frame is supported by the box style enclosure. When installed in a ceiling which has a thickness greater than ½″, the plaster flange frame may be adjusted by loosening mechanical fasteners and pulling the plaster flange frame down to meet the ceiling. This expands the internal volume of the fixture, which reduces internal temperatures and extends the life of the internal components. After adjusting the plaster flange frame the fasteners may be tightened to lock the position. This resolves the limitation of installing the fixture in only ½″ ceilings.

The mounting bars which support the fixture consist of two U-shaped bars. There are fasteners mounted on each corner at an angle so that the installer can drive the fasteners easier from below. There is a flange at each corner of the U-shaped bar which is formed to fit under a wooden joist. There is also one flange centered within the bar, parallel with the corner flanges, running substantially across the length of the bar. This allows the user to use the combination of flanges to level the fixture with the joists. This reduces the time which would be required if the fixture had four individual bars with four separate mounting flanges.

As the fixture is wired the junction box must be opened to install the wiring. Known recessed lighting fixtures have loose covers or covers with hinges. The disclosed recessed lighting fixture has a cover which is installed with two screws. A screw on the horizontal surface may be loosened to allow the cover, which is “L” shaped, to swing down and expose one vertical opening and a partial opening of the bottom. This allows maximum access to the junction box. If needed, the screw on the vertical surface may be loosened. When loosened, the cover will open, pivoting on the screw which is installed in the horizontal surface. This allows the door to swing open 90 degrees to the junction box. Unlike hinged doors, this has two axis of rotation and is easily removed. Hinged doors allow one axis of rotation and may be difficult to remove, due to the angle at which the door is needed to extend past the hinge.

Fixtures with multiple colors of LED's are used to display a multitude of colors. The array of colors is possible due to dimming the individual colors to show only one color or those which are possible through the mixing of colors at varying intensities. To control the intensity, controls are used to send signals to the fixtures. The fixture accepts the signal from the controller and adjusts per the signal sent. There are protocols for these signals. Two of the most popular signal protocols are DMX and 0-10 volt. State of the art fixtures are built to accept one signal only. This forces the contractor to purchase only those controls which are compatible with the signal protocol built into the fixture. The choice of controls is typically limited and often costly. This may influence the building owner to decide against purchasing a certain fixture type. The current invention is built with a module which accepts both DMX and 0-10 volt signals. This module also provides power to the LED's. The decision regarding the control can be decided the day that wiring is installed, offering more choices and a wider range of costs.

State of the art, flush mounted fixtures require the ceiling surface to be finished up to the edge of the fixture nearest the aperture. A perforated metal flange, mounted on the fixture, is typically used to define the area where the ceiling must be finished. The aperture is the hottest portion of the fixture and most building materials will dry out when installed in this manner. The dried out building material will then crack. The cracking becomes worse when a trim must be removed from the housing. The disclosed recessed lighting fixture is built to drop through the ceiling, which means the ceiling is finished to the outside edge of the housing, not the aperture. The outside edge of the housing runs 20 to 30 degrees Celsius cooler than the portion nearest the aperture. The lower temperature means that the building material used to finish the ceiling will last longer, preventing the material from being dried out. Replacing the perforated metal flange is a channel which starts at the inside edge of the flange frame. The channel provides a natural space to trowel off building material and end the finish line.

Directional light sources must be operated at their proper temperature in order to achieve the full life of the lamp. State of the art fixtures use lamp housings which have ventilation. Ventilation lowers lamp temperatures and extends life. The ventilation typically allows light and heat to escape. The disclosed recessed lighting fixture keeps light from escaping and reflecting off of the dome, but still allow heat to escape. The disclosed recessed lighting fixture covers the back side of the lamp and a portion of the mounting ring into which the lamp mounts. The cover surrounding the back of the lamp maintains a space between the mounting ring and the cover. This space allows cooler air to enter and the hotter air escapes out the backside through the hole cut for the socket to enter. This cover is black, greatly reducing reflections; it also blocks all direct light from the lamp.

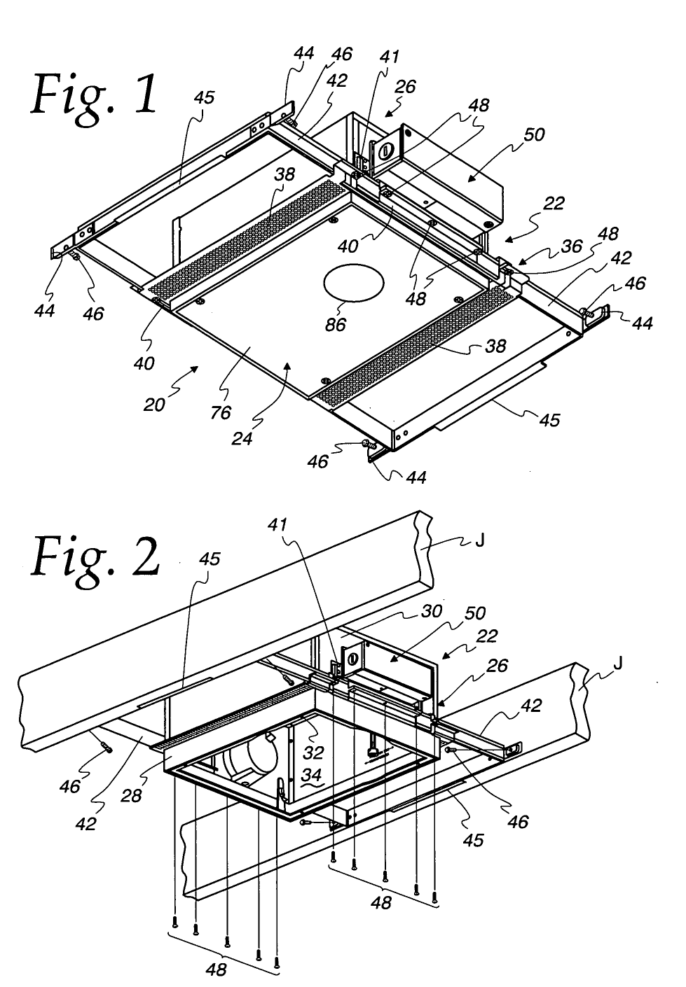

Referring initially to FIG. 1, a recessed lighting fixture 20 in accordance with the invention is illustrated. The recessed lighting fixture comprises a housing assembly 22 and a removable plaster plate assembly 24, shown removed in FIG. 2. The housing assembly 22 is a two-part, expandable housing substantially surrounding the plaster plate assembly 24. The housing assembly 22 consists of an upper assembly 26, in the form of a box style enclosure, and a lower assembly 28, referred to as a plaster flange frame. The plaster plate assembly 24 is secured to the plaster flange frame 28, while the plaster flange frame 28 is adjustably mounted to the box style enclosure 26.

The box style enclosure 26 is generally of parallelepiped shape having a peripheral side wall 30 closed by a top wall 32 to define an interior space 34. The box style enclosure 26 is open at the bottom to provide bottom access to the interior space 34.

A frame 36 surrounds the box style enclosure 26 and includes opposite longitudinally extending perforated plates 38, defining drywall anchor screens, connected by opposite transversely extending channel sleeves 40. Brackets 41 extend upwardly from each channel sleeve 40 and are secured to the peripheral side wall 30 to secure the frame 36 to the box style enclosure 26. The channel sleeves 40 slidably receive opposite U-shaped mounting hanger bars 42. The mounting hanger bars 42 include end tabs 44 each having a fastener 46 for securing the housing assembly 22 to ceiling joists J. A flange 45 is provided on an underside of each mounting hanger bar 42 to level the fixture 20 with the joists J. A plurality of threaded fasteners 48 are threadably received in the channel sleeves 40 for securing the mounting hanger bars 42 relative to the box style enclosure 26 to provide appropriate centering when mounting the housing assembly 22 between the joists J.

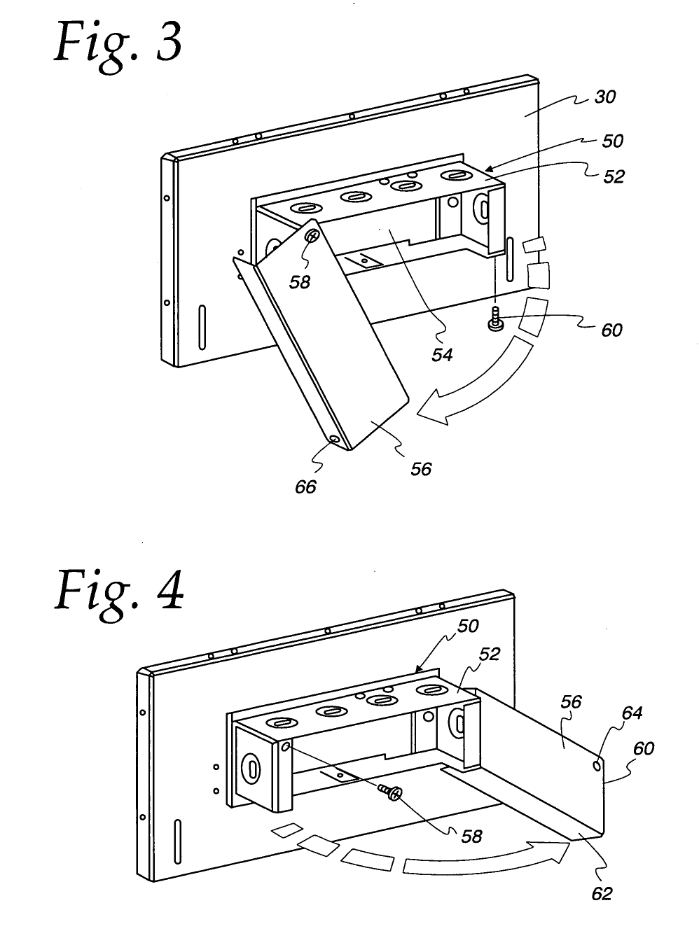

Referring also to FIGS. 3 and 4, an electrical junction box 50 is mounted to the housing peripheral side wall 30. The junction box 50 comprises a peripheral side wall 52 connected to the housing side wall 30 about an opening 54. The opening 54 may be closed by an interior plate, as necessary. A cover 56 is operatively connected to the junction box 50 to allow it to be rotated on either a horizontal or vertical plane when one of two screws 58 or 60 is removed. Particularly, the cover 56 comprises an outer wall 60 and a bottom flange 62. The outer wall 60 includes a through opening 64 at one corner. The flange 62 includes a through opening 66 at a corner diametrically opposite the opening 64. The first opening 64 receives the first screw 58 to allow the cover 56 to rotate along a vertical plane, as shown in FIG. 3. The second screw 60 is receivable in the second opening 66 to screw to an underside of the peripheral wall 52 to allow the cover 56 to rotate in a horizontal plane, as shown in FIG. 4.

To install the fixture 20, as shown in FIG. 2, the housing assembly 22 is held in place at an appropriate longitudinal position between the ceiling joists J. The mounting hanger bars 42 are positioned to abut a face of the joists J with the flanges 45 against a lower edge of the joists J. The fasteners 46 are then secured to the joists J in a conventional manner. The fasteners 46 may be threaded fasteners or may be nails that are driven into the joists J. Thereafter, the housing assembly 22 can be moved laterally relative to the joists so that the housing assembly 22 is properly positioned between the joists J. Once the housing assembly 22 is positioned as desired, then the fasteners 48 are tightened to affix the housing assembly 22 to the mounting hanger bars 42. The installer can then pull on the fixture to ensure that there is no movement.

Once the housing assembly is properly installed, as described, the appropriate electrical connections can be made via the junction box 50, as described below.

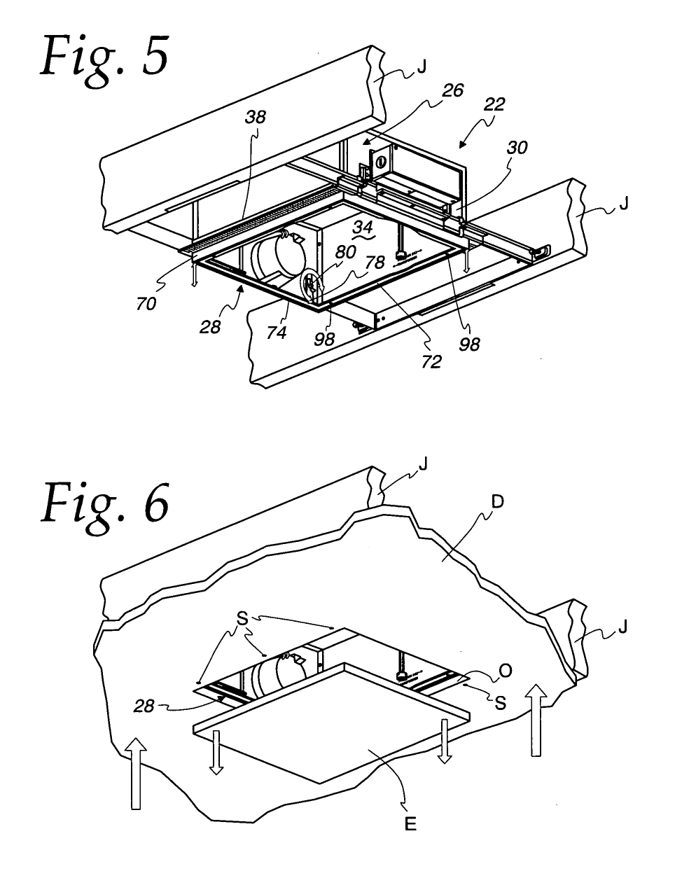

Referring to FIG. 5, the plaster flange frame 28 comprises a peripheral side wall 70 telescopically received on the box style enclosure peripheral side wall 30. A flange 72 extends inwardly from the side wall 70 inset from a lower edge 74 of the side wall 70. The spacing between the flange 72 and the edge 74 is dependent upon thickness of a base plate 76 of the plaster plate assembly 24 so that the base plate 76 would be substantially flush with the lower edge 74, as discussed below. Four slotted flange brackets 78, one of which is shown, extend upwardly from the flange 72. The slotted flange brackets 78 are slidably received on wing nut connectors 80 on the inside of the enclosure side wall 30, in the interior space 34. With the wing nuts 80 loosened, the plaster flange frame 28 can be telescopically moved up and down relative to the housing enclosure 26.

Referring to FIG. 6, a drywall installer installs a sheet of drywall D to the joists J and cuts an opening O removing excess E. The opening O is sized for the plaster flange frame 28. The plaster flange frame 28 is thus received in the opening O. The drywall D is anchored to the drywall anchor screen 38 as by inserting screws S through the drywall D into the anchor screens 38.

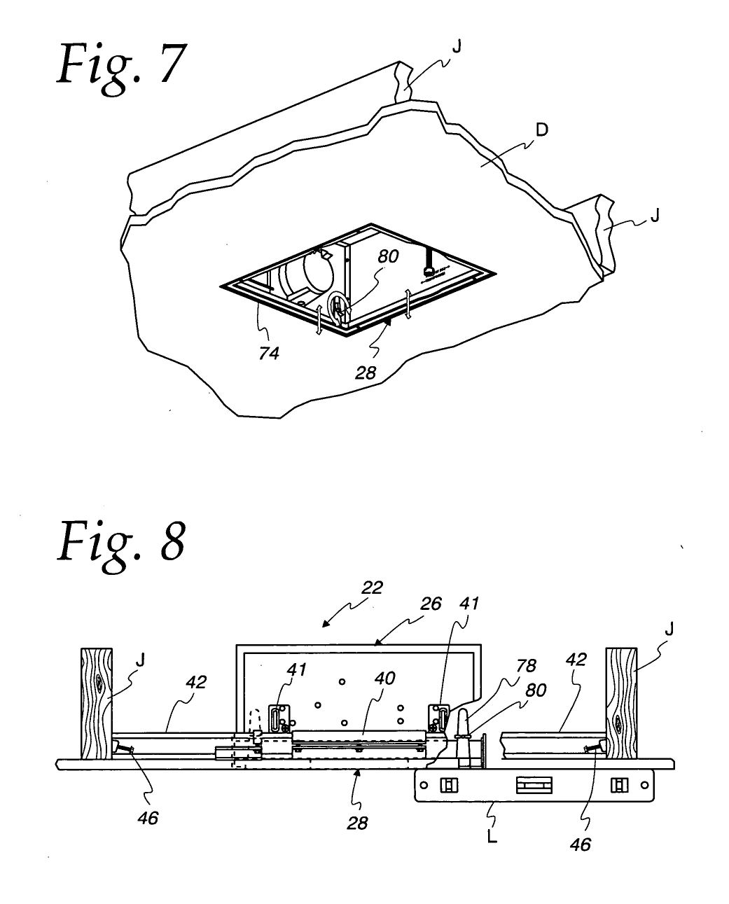

Referring to FIGS. 7 and 8, once the drywall D is installed, the wing nuts 80 are loosened and the plaster flange frame 28 is adjusted so that its lower edge 74 is flush with the lower surface of the drywall D. All four corners must be exactly even with the drywall. The plaster flange frame 28 is adapted to be adjustable to accommodate ½ inch to 1¼ inch ceiling thickness. As shown in FIG. 8, a level L or straight edge is used to provide the required flush mounting as shown. As each corner is determined to be flush, then the wing nuts 80 can be tightened securely.

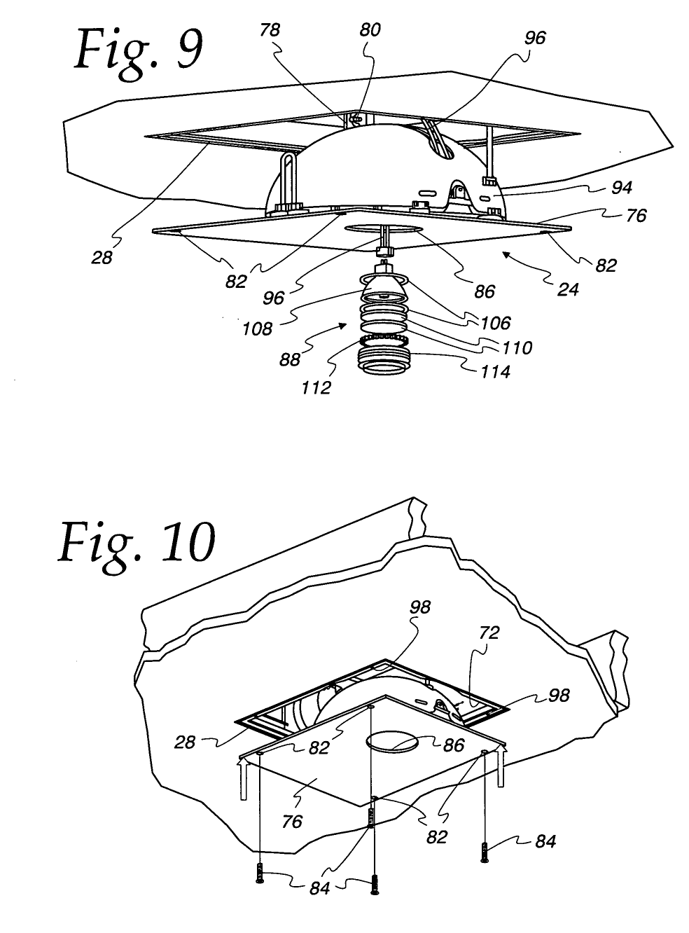

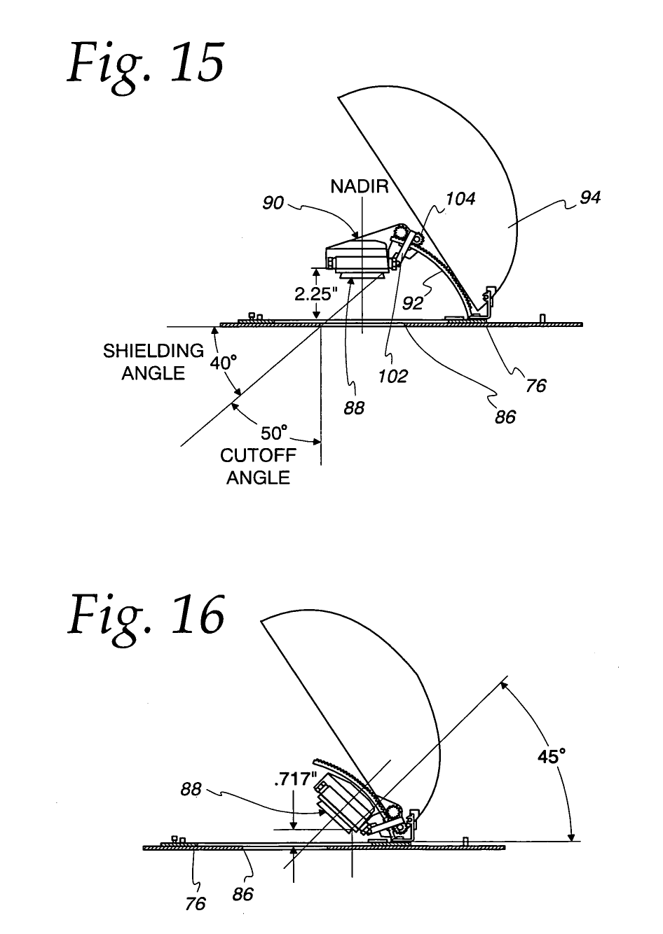

Referring to FIG. 9, the plaster plate assembly 24 is illustrated. Except as otherwise described herein, the plaster plate assembly 24 is generally similar to that disclosed in pending U.S. patent application Ser. No. 11/440,961, the specification of which is incorporated by reference herein. The plaster plate assembly 24 includes the base plate 76 which is generally rectangular and of a size to be received in the plaster flange frame 28. An opening 82 is provided at each corner for receiving fasteners 84, see FIG. 10. A central opening 86 defines a light opening. A lamp assembly 88 is receivable in a back light shield 90, see FIG. 15, mounted to an arcuate rack 92. The arcuate rack 92 may be as described in the pending application incorporated by reference herein and is mounted to a back surface of the base plate. A curved dome 94 is hingedly mounted to the back surface of the base plate 76 for covering the shield 92. A lamp assembly electrical cable 96 extends through the shield 90 and an opening in the dome 94 and is terminated as described below.

The base plate 76 is loosely attached to the plaster flange frame 28 using the four screws 84 extending through the openings 82 into corresponding threaded openings 98 in the flange 72. After all four screws 84 are started, they can all be tightened securely so that a front surface of the base plate 76 is substantially flat and aligned with the drywall. Thereafter, the lamp can be tested to ensure that it is properly installed and appropriately adjusted, as described below. A channel greater than 0.060″ is formed between the base plate 76 and the plaster flange frame edge 74.

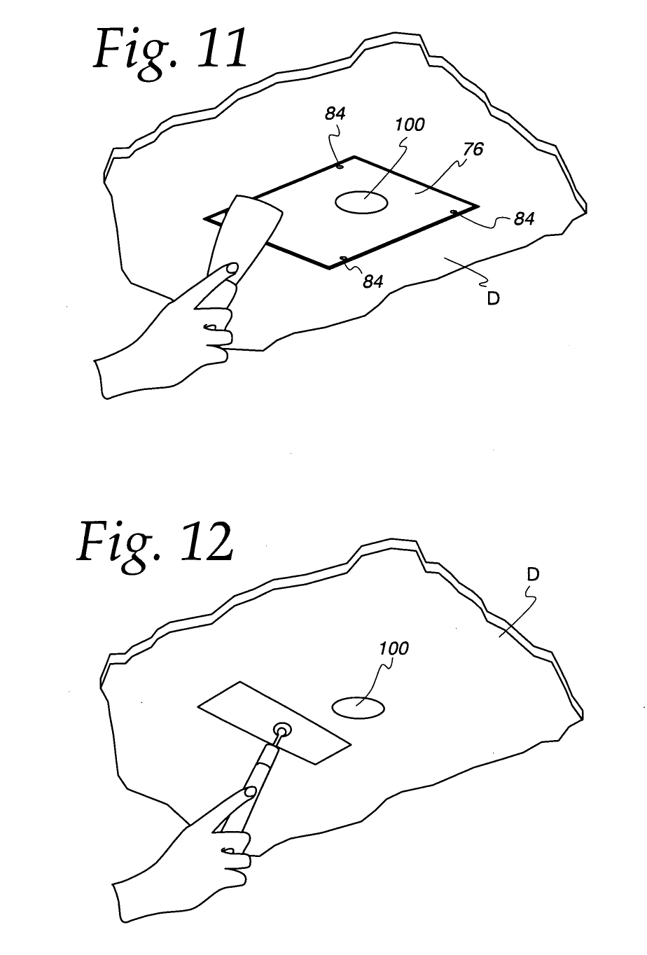

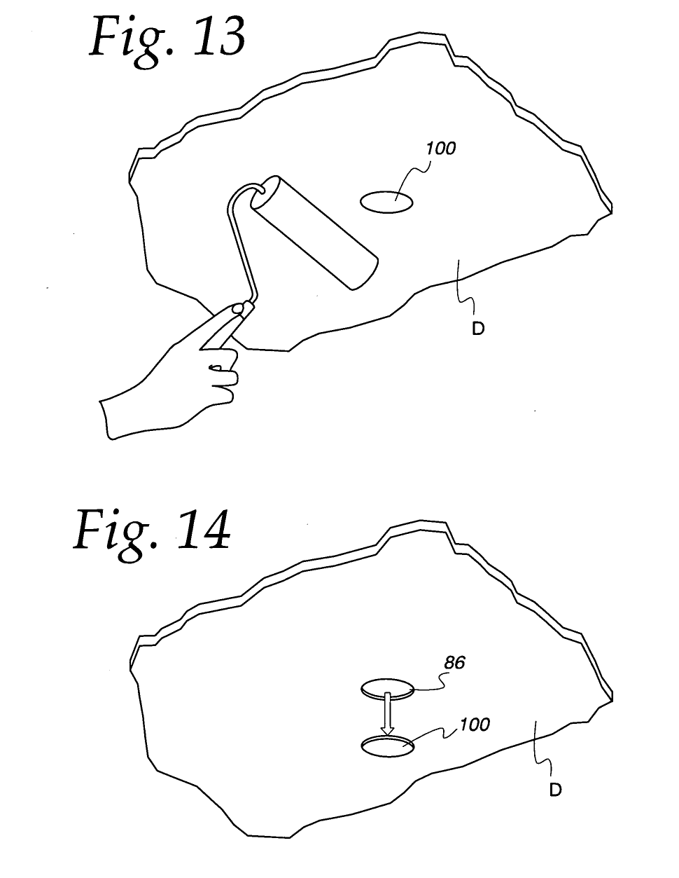

Referring to FIG. 11, the opening 86 is covered by a paint shield 100. The paint shield 100 protects the inside of the fixture 20 from overspray and paint which may be rolled onto or over the edge of the hole without damaging the paint on the finished surface after removal. A paint resistant coating may be applied around the hole 86 of the base plate 76 to prevent paint from adhering to the surface area surrounding the hole to the inside of the light fixture. Plaster, or the like, is then applied about the edges of the base plate 76 to at least cover the screws 84. The installation can then be sanded, as shown in FIG. 12, painted as shown in FIG. 13, and then the paint shield 100 removed as shown in FIG. 14 to expose the opening 86.

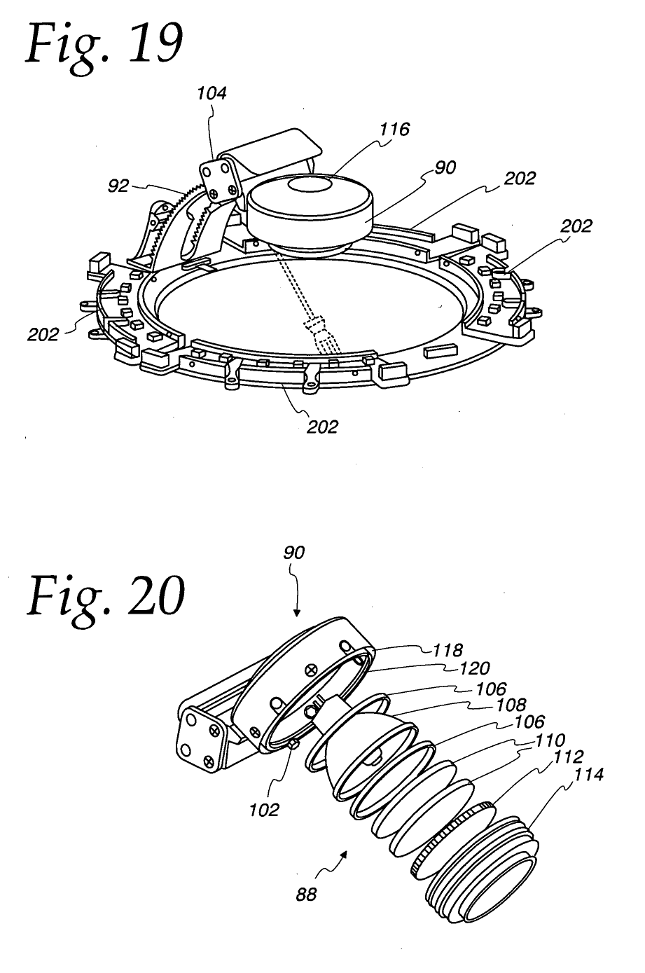

The light orientation can be adjusted as described relative to FIGS. 15 and 16. Particularly, a rotary stem 102 operates a gear mechanism 104 which moves the shield 90 along the track 92. This offers 0 to 45 degree vertical adjustment without beam clipping. The gear adjustment is concealed behind the shield 90. The shield 90 houses the lamp assembly 88, see FIGS. 9 and 20, comprising locking rings 106, an MR16 lamp 108, lenses 110, a louver 112 and a snoot 114. The lenses and louver are optionally provided. As is apparent, other lamp styles may also be used. The shield 90 keeps light from escaping and reflecting off of the dome, but still allows heat to escape through its back opening 116, see FIG. 19. It also maintains a space between the lamp assembly 88 and the dome 94. Front ventilation is provided by an annulus 118 between the shield 90 and a gimbal ring 120.

As shown in FIG. 15, a 50 degree cutoff angle, as defined from the vertical centerline of the aperture (nadir) up towards the ceiling plane, is the ideal angle for glare control. Considering a line of sight tangent to the edge of the light source farthest from the viewer, the lamp will not be visible until the line of sight angle is greater than 40 degrees from the ceiling plane, through the aperture 86. Many fixtures have an additional trim which is mounted at the ceiling plane to define the cutoff angle. The disclosed recessed lighting fixture 20 does not have a trim. Further, the aperture 86 for the disclosed recessed lighting fixture is effectively plastered in place and not intended to be removed for service. This means that the cutoff angle is determined by the distance from the plate 76 which has been plastered into the ceiling and not from the bottom edge of a trim, which is removable. The distance to a plaster plate, which is common to most recessed fixtures, to achieve a 50 degree cutoff is different than fixtures with trims because the ceiling is typically between the trim and the plaster plate. The disclosed recessed lighting fixture 20 drops through the ceiling, so the ceiling thickness is not included in the equation. Fixtures with trims and apertures smaller than 3.5″ often block a portion of the main beam candlepower when the light source is directed through the trim. This is true especially when the lamp is angled 45 degrees from the vertical centerline. The disclosed recessed lighting fixture maintains the cutoff angle at all viewing angles without blocking any of the main beam candlepower when the lamp is positioned straight down. When the lamp is positioned approximately ¾ inch (0.717″ in the illustrated embodiment) above the front surface of the base plate 76, at an angle 45 degrees, as in FIG. 16, from the vertical center line, none of the main beam candlepower is blocked.

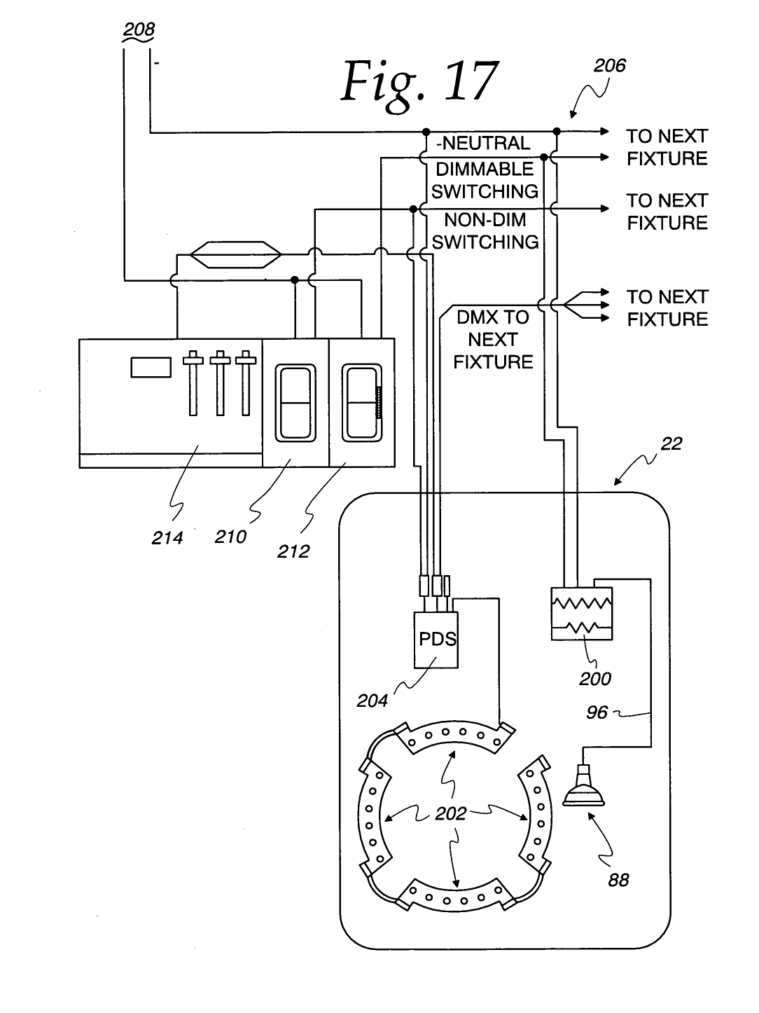

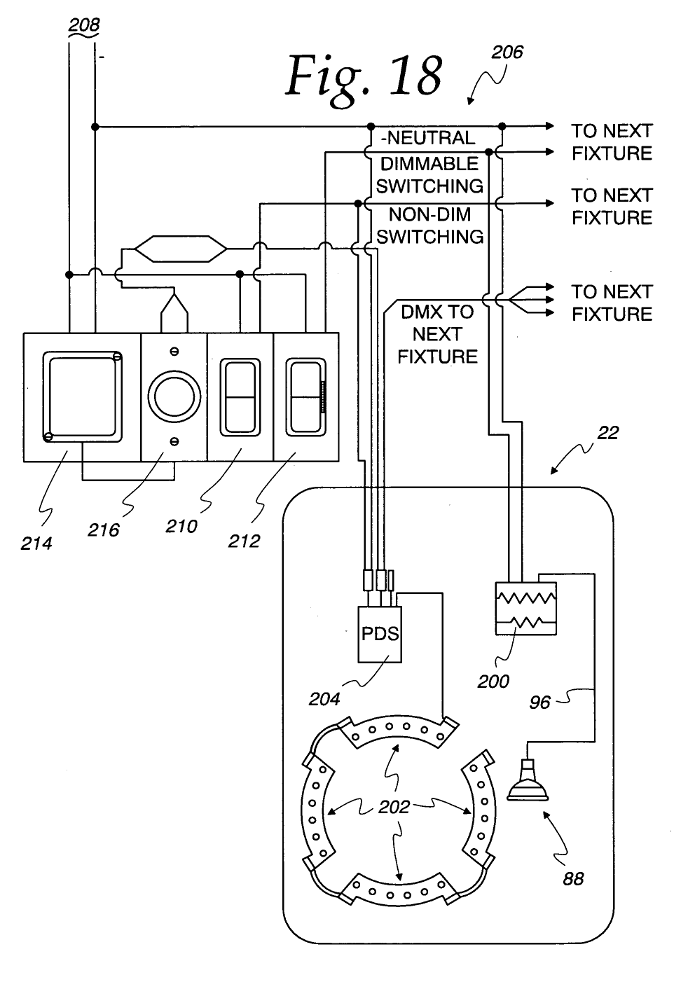

Referring to FIGS. 17 and 18, electrical connection alternatives are illustrated. Included within the housing assembly 22 is the lamp assembly 88 electrically connected to a 120 volt 75 watt magnetic transformer 200. Four LED sections 202 are connected to an LED driver/power data supply (PDS 204). The PDS 204 may be controlled by either conventional DMX controls, as in FIG. 17, or 0-10 volt analog dimmer controls, as in FIG. 18. The various connections are made using circuitry 206 housed in the junction box 50.

Referring to FIG. 17, a line input 208 provides 120 volt to 240 volt input power. The power is supplied to an on/off switch 210 and a magnetic low voltage dimmer 212. The on/off switch is electrically connected to the PDS 204. The dimmer 212 is electrically connected to the transformer 200. A conventional DMX control 214 is also connected to the PDS 204. As is indicated, the various connections can then be daisy chained to other fixtures.

Referring to FIG. 18, the line input is again provided to the on/off switch 210 and the magnetic low voltage dimmer 212 which are connected as with FIG. 17. The line input is also connected to a power supply 214 which provides 24 volt DC power to a variable controller 216 which provides a 0 to 10 volt DC signal to the PDS 204.

Thus, as is described, the PDS 204 can control the LED sections 202 from either a DMX control or a 0 to 10 volt analog signal.

Although the fixture 20 is described mounted in a drywall ceiling, the fixture 20 could similarly be wall mounted and could be used with other surfaces, including plaster or other types of surfaces, as will be apparent.

Thus, in accordance with the invention, there is described a recessed lighting fixture comprised of several elements beneficial to finishing the installation of a flush-mounted fixture in a plaster or drywall installation. The recessed lighting fixture allows the base plate to be mounted flush with the ceiling/wall in multiple ceiling/wall thicknesses, ease the alignment and leveling of the fixture, and reduce the amount of parts which may be lost or damaged at the job site, and increase the wattage rating when UL listed for use in IC rated applications. The combination of these features allows for the housing to be installed in multiple ceiling/wall thicknesses with reduced labor compared to present inventions.

The recessed lighting fixture comprises a base plate mountable in an opening in a room ceiling or wall, the base plate defining spaced apart front and back surfaces wherein the front surface is substantially flat and aligned with the surface of said ceiling or wall when mounted thereon, capable of being plastered and painted to match the ceiling or wall into which it is installed, said plate having a hole to allow light to pass through. A two-part, expandable housing substantially surrounds the base plate, the housing consisting of an upper and lower assembly, with the base plate secured to the lower portion and the lower portion adjustably mounted to the upper portion of the housing. A curved dome is adjustably mounted adjacent the back surface of the base plate, contained within the housing and centered on said light opening.

I claim:

1. A recessed lighting fixture comprising:
a base plate mountable in an opening in a room ceiling or wall, the base plate defining spaced apart front and back surfaces wherein the front surface is substantially flat and aligned with a surface of said ceiling or wall when mounted thereon, capable of being plastered and painted to match the ceiling or wall into which it is installed, said plate having an opening to allow light to pass through; and
a two-part, expandable housing substantially surrounding the base plate, the housing comprising an upper and lower assembly, with the base plate secured to the lower assembly and the lower assembly being adjustably mounted to the housing upper assembly.

2. The recessed lighting fixture of claim 1 comprising a channel between the base plate and the housing lower assembly.

3. The recessed lighting fixture of claim 1 further comprising U-shaped mounting brackets, adjustably mounted to the housing upper assembly to secure the light fixture to a supporting structure.

4. The recessed lighting fixture of claim 1 further comprising a junction box cover mechanically secured to a portion of the housing upper assembly on at least one horizontal and one vertical surface such that the junction box cover can be rotated on either a horizontal or vertical plane.

5. The recessed lighting fixture of claim 1 further comprising an electronic module capable of communicating with wall controls through either a digital or analog signal to control the intensity of at least one light source within the light fixture.

6. The recessed lighting fixture of claim 1 further comprising a curved dome adjacent said back surface of said base plate and centered on said light opening.

7. The recessed lighting fixture of claim 1 further comprising a light cutoff angle of 50 degrees, as measured from Nadir, when a lamp is positioned above the front surface, on a vertical axis of the light opening.

8. The recessed lighting fixture of claim 1 further comprising a 45 degree lamp aiming angle and no loss in main beam candlepower when a lamp is positioned about 0.75″ above the front surface, and 45 degrees off of a vertical axis of the light opening.

9. The recessed lighting fixture of claim 1 further comprising a lamp assembly mounted to the base plate.

10. The recessed lighting fixture of claim 9 wherein the lamp assembly is adjustably mounted to the base plate using an arcuate rack.

11. The recessed lighting fixture of claim 9 wherein the lamp assembly comprises a shield receiving a lamp, the shield preventing light from escaping into the housing upper assembly.

12. The recessed lighting fixture of claim 11 wherein the shield comprises front and rear ventilation openings.

13. A recessed lighting fixture comprising:
an expandable housing mountable in an opening in a room ceiling or wall, including an upper enclosure and a lower flange frame adjustably mounted to the upper enclosure;
mounting brackets adjustably mounted to the upper enclosure to secure the fixture to a supporting structure;
a base plate mounted to the flange frame and defining spaced apart front and back surfaces wherein the front surface is substantially flat and aligned with a surface of said ceiling or wall when mounted thereon, capable of being plastered and painted to match the ceiling or wall into which it is installed, said base plate having an opening to allow light to pass through; and
a lamp assembly mounted to the back surface of the base plate proximate the light opening.

14. The recessed lighting fixture of claim 13 comprising a channel between the base plate and the flange frame.

15. The recessed lighting fixture of claim 13 wherein the mounting brackets are U-shaped and comprise fasteners to secure the light fixture to a supporting structure.

16. The recessed lighting fixture of claim 13 further comprising a cover mechanically secured to a junction box on the upper enclosure on at least one horizontal and one vertical surface such that the junction box cover can be rotated on either a horizontal or vertical plane.

17. The recessed lighting fixture of claim 13 further comprising an electronic module capable of communicating with wall controls through either a digital or analog signal to control the intensity of at least one light source within the lighting fixture.

18. The recessed lighting fixture of claim 13 further comprising a curved dome adjacent said back surface of said base plate and centered on said light opening.

19. The recessed lighting fixture of claim 13 further comprising a light cutoff angle of 50 degrees, as measured from Nadir, when a lamp is positioned on a vertical axis of the light opening.

20. The recessed lighting fixture of claim 13 further comprising a 45 degree lamp aiming angle and no loss in main beam candlepower when a lamp is positioned about 0.75″ above the front surface, and 45 degrees off of a vertical axis of the light opening.

21. The recessed lighting fixture of claim 13 wherein the lamp assembly is adjustably mounted to the base plate using an arcuate rack.

22. The recessed lighting fixture of claim 13 wherein the lamp assembly comprises a shield receiving a lamp, the shield preventing light from escaping into the housing upper assembly.

23. The recessed lighting fixture of claim 22 wherein the shield comprises front and rear ventilation openings.
